(19) United States
(12) Patent Application Publication
(10) Pub. No.: US 2026/0241951 A1
(43) Pub. Date: Aug. 20, 2026

(54) SYSTEM AND METHOD FOR VEHICLE OPERATION BASED ON SUN POSITION

(71) Applicant: Torc Robotics, Inc., Blacksburg, VA (US)

(72) Inventors: Maximilian Yassine Beyen, Leutenbach (DE); Simon Baeuerle, Kassel (DE); Maximilian Koeper, Ostfidern (DE); Marat Kopytjuk, Heilbronn (DE); Margarita Kunjavskaja, Gerlingen (DE)

(21) Appl. No.: 19/053,557

(22) Filed: Feb. 14, 2025

(51) Int. Cl. B60W 60/00

(52) U.S. Cl. CPC B60W 60/001; B60W 2420/403; B60W 2420/408; B60W 2720/10

(57) ABSTRACT

A system for vehicle operation based on sun position is provided. The system includes at least one sensor configured to be located on a vehicle. The system includes a processing device in communication with the at least one sensor. The processing device is configured to execute instructions stored in a memory to perform operations including detecting with the at least one sensor a sun position relative to the vehicle. The operations include determining if the detected sun position is within a predetermined threshold range. If the detected sun position is within a predetermined threshold range, the operations include initiating a modified operation of the vehicle.

### TECHNICAL FIELD

The field of the disclosure relates to vehicle operation optimization and, in particular, to a system for vehicle operation based on sun position to optimize sensor perception during route planning and route completion.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is located. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. These actions undertaken by the vehicle include steering, braking and acceleration.

Although multiple sensors are generally used to assist with operation and guidance of the vehicle, the perception quality of certain sensors—such as cameras or other optical sensors—may be affected by the position of the sun. During sunrise and sunset timeframes, the sun is positioned at a low elevation and may interfere with perception of some sensors. The sensor(s) may fail to detect an object on the roadway due to the rays of the sun creating a glare, or may only partially detect the object without accurately detecting the full extent of the object on the roadway. Therefore, such interference from the sun can result in misdetection and inaccurate data gathering, which can lead to hazardously misleading information (HMI) events.

Accordingly, there exists a need for a system and a method for vehicle operation based on sun position which adjusts operation of the vehicle to increase sensor confidence during specific sun position timeframes. These and other needs are met by the exemplary system for vehicle operation based on sun position discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for vehicle operation based on sun position is provided. In some embodiments, the vehicle can be, e.g., an autonomous vehicle, a semi-autonomous vehicle, or a non-autonomous vehicle. The system includes at least one sensor configured to be located on a vehicle. The system includes a processing device in communication with the at least one sensor. The processing device is configured to execute instructions stored in a memory to perform operations including detecting with the at least one sensor a sun position relative to the vehicle. The operations include determining if the detected sun position is within a predetermined threshold range. If the detected sun position is within a predetermined threshold range, the operations include initiating a modified operation of the vehicle.

In some embodiments, detecting with the at least one sensor the sun position relative to the vehicle can include determining the sun position relative to a horizontal plane extending in front of the vehicle. In some embodiments, the predetermined threshold range can include an angle of about, e.g., 30 degrees or less, from the horizontal plane. In some embodiments, detecting with the at least one sensor the sun position relative to the vehicle can include determining the sun position relative to a horizontal plane defined by a road in front of the vehicle. The sun position relative to the vehicle can include an azimuth value and an elevation value. The sun position can be within the predetermined threshold range during sunrise or sunset.

In some embodiments, initiating the modified operation of the vehicle can include generating a modified route for the vehicle to avoid the sun position within the predetermined threshold. In some embodiments, the modified route can include a direction of travel of the vehicle opposite of a sun travel position. In some embodiments, the modified route can include the direction of travel west during morning travel and the direction of travel east during evening travel of the vehicle.

In some embodiments, initiating the modified operation of the vehicle can include dynamically weighing a confidence value associated with perception accuracy of the at least one sensor based on the sun position within the predetermined threshold range. In some embodiments, the operations can include transferring at least a portion of captured perception data from the at least one sensor to at least one secondary sensor, and fusing the captured perception data from the at least one sensor and the at least one secondary sensor.

In some embodiments, the operations can include assigning greater weight to the captured perception data from the at least one secondary sensor than to the captured perception data from the at least one sensor. In some embodiments, a perception capability of the at least one sensor can be affected by the sun position in the predetermined threshold range, and a perception capability of the at least one secondary sensor is not affected by the sun position in the predetermined threshold range.

In some embodiments, the at least one sensor can be, e.g., a camera, and the at least one secondary sensor can be, e.g., at least one of LiDAR or radar. In some embodiments, initiating the modified operation of the vehicle can include reducing a speed of the vehicle for safer travel during reduced perception with the at least one sensor. In some embodiments, initiating the modified operation of the vehicle can include generating a modified route for the vehicle with flat terrain.

In some embodiments, initiating the modified operation of the vehicle can include at least one of (i) generating a modified route for the vehicle to avoid the sun position within the predetermined threshold, (ii) dynamically weighing a confidence value associated with perception accuracy of the at least one sensor based on the sun position within the predetermined threshold range, transferring at least a portion of captured perception data from the at least one sensor to at least one secondary sensor, and fusing the captured perception data from the at least one sensor and the at least one secondary sensor, (iii) reducing a speed of the vehicle for safer travel during reduced perception with the at least one sensor, (iv) generating a modified route for the vehicle with flat terrain, (v) modifying the speed of the vehicle, (vi) performing a minimal risk maneuver, or (vii) increasing a safety distance relative to other road users.

In another aspect, an exemplary computer-implemented method for vehicle operation based on sun position is provided. The method includes detecting with at least one sensor configured to be located on a vehicle a sun position relative to the vehicle. The method includes executing instructions stored in a memory with a processing device in communication with the at least one sensor to perform operations including determining if the detected sun position is within a predetermined threshold range. If the detected sun position is within a predetermined threshold range, the method includes initiating a modified operation of the vehicle.

In some embodiments, initiating the modified operation of the vehicle can include generating a modified route for the vehicle to avoid the sun position within the predetermined threshold. The modified route can include a direction of travel of the vehicle opposite of a sun travel position. In some embodiments, initiating the modified operation of the vehicle can include dynamically weighing a confidence value associated with perception accuracy of the at least one sensor based on the sun position within the predetermined threshold range. In such embodiments, the operations can include transferring at least a portion of captured perception data from the at least one sensor to at least one secondary sensor, and fusing the captured perception data from the at least one sensor and the at least one secondary sensor. In some embodiments, initiating the modified operation of the vehicle can include reducing a speed of the vehicle for safer travel during reduced perception with the at least one sensor. In some embodiments, initiating the modified operation of the vehicle can include increasing a safety distance relative to other road users.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for vehicle operation based on sun position.

FIG. 7 is a flowchart of a method for vehicle operation based on sun position.

FIG. 8 is an image captured by a sensor of a vehicle during a sun position outside of a predetermined threshold range.

FIG. 9 is an image captured by a sensor of a vehicle during a sun position within a predetermined threshold range, resulting in potential misdetection of objects.

FIG. 10 is a schematic side view of a vehicle and sensor relative to a sun position.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for vehicle operation takes into account the position of the sun to ensure that the sensors of the vehicle are operating at optimal perception levels, thereby gathering accurate data regarding the environment through which the vehicle is traveling. The exemplary system can take into account the position of the sun during a route planning phase to avoid or reduce instances in which the sun position can affect the effective perception of the sun. By generating a route for the vehicle which avoids or limits sun position interference with optimal sensor operation, the confidence level of the sensor operation can be increased to safely guide the vehicle through the environment.

In determining the sun position, the system can consider one or both of the elevation and the azimuth angles of the sun relative to the vehicle and/or the roadway. In some embodiments, the system can use a horizontal as the baseline from which the elevation and azimuth angles are measured. The elevation and azimuth angles can be determined based on vehicle sensor detection of the sun position. In some embodiments, the sun position can be determined or estimated based on historical sun position data such that the system can be used to plan a route with the expected sun position taken into account to avoid safety critical situations.

In some embodiments, generating a route which avoids certain interfering sun positions may not be possible. In such embodiments, the system can execute a dynamic weighing algorithm to weigh the effect and influence of different sensors of the vehicle based on the impact of the sun position. For example, during sunset and sunrise timeframes when the sun is positioned within a specific elevation and/or azimuth angle, the system can determine that outwardly facing cameras of the vehicle have a reduced perception confidence. The system can therefore apply a lower weight to data from the cameras, and can apply a greater weight to data from other sensors having a higher perception confidence value, e.g., radar, LiDAR, or the like. By shifting the weight of the data to other sensors having a higher perception confidence value, the system ensures that accurate data is being used for guiding of the vehicle through the environment. The weighing algorithm can be performed dynamically and in real-time based on the position of the sun. If the sunset and/or sunrise timeframe has passed and the sun position is outside of a threshold elevation and/or azimuth angle, the system can gradually transition increase the weight of the data from the cameras in the guidance determination for the vehicle.

In some embodiments, weather data can be used to determine if the sun position is used to adapt a route for the vehicle. In some embodiments, the weather data can be current weather data and/or future forecasted data. For example, if the sun position is within a predetermined elevation and/or azimuth angle that would typically warrant reduction of weight of the camera sensor data, but the current weather conditions are cloudy, the system can maintain the normal weight of the camera sensor data due to lack of interference from the sun. As a further example, if the forecasted weather data shows that cloudy skies are expected during the sunset timeframe of the mission, the system can determine that a modification of the mission route (or a planned adjustment of weighing of the sensor data) need not be performed due to lack of interference from the sun. The system can perform these types of adjustments in real-time based on detection of the sun position and the weather conditions. However, the forecasted weather data can be used to assist with mission route planning and/or adjustment.

Therefore, in some embodiments, the system can determine the expected sun position before a route is initiated, and the sun position (azimuth and/or elevation angles) can be combined with a road network from a map to determine a safer route for the vehicle from a starting location to a stopping location. For example, if the sun is known to travel from east to west, the system can plan routes for the vehicle that avoid traveling directly (or substantially directly) into the sun direction. In some embodiments, the system can generate a route for the vehicle that avoids or limits travel of the vehicle into a direction where the sun is located within a 45 degrees angle, e.g., an azimuth angle range. In some embodiments, the azimuth angle range can be about, e.g., 0 -100 degrees inclusive, 0 -90 degrees inclusive, 0 -80 degrees inclusive, 0 -70 degrees inclusive, 0 -60 degrees inclusive, 0 -50 degrees inclusive, 0-45 degrees inclusive, 0 -40 degrees inclusive, 0 -30 degrees inclusive, 0 -20 degrees inclusive, 0 -10 degrees inclusive, 10-100 degrees inclusive, 20-100 degrees inclusive, 30-100 degrees inclusive, 40-100 degrees inclusive, 45-100 degrees inclusive, 50-100 degrees inclusive, 60-100 degrees inclusive, 70-100 degrees inclusive, 80-100 degrees inclusive, 90-100 degrees inclusive, 20-80 degrees inclusive, 30-70 degrees inclusive, 40-60 degrees inclusive, 30-45 degrees inclusive, 100 degrees, 90 degrees, 80 degrees, 70 degrees, 60 degrees, 50 degrees, 45 degrees, 40 degrees, 30 degrees, 20 degrees, 10 degrees, or the like, with a centerpoint of the range aligned with a centerpoint of the field-of-view of the respective sensor. The system can generate a route for the vehicle to travel west in the mornings during sunrise such that the sun rises in the east behind the vehicle and, therefore, does not interfere with perception of front-facing sensors of the vehicle, e.g., generally east to west morning travel. Similarly, the system can generate a route for the vehicle to travel east in the evenings during sunset such that the sun sets in the west behind the vehicle and, therefore, does not interfere with perception of front-facing sensors of the vehicle, e.g., generally west to east morning travel. The vehicle route can be adapted to avoid or limit driving towards the sun position.

In some embodiments, if traveling into the direction of the sun position cannot be avoided, and the sensor confidence values cannot be dynamically weighed to ensure safe operation of the vehicle, the system can generate an alert to mission control and/or a driver in the vehicle to request driver takeover. In particular, to avoid safety critical situations, e.g., on a highway, the system can trigger the driver to take over the vehicle operation to avoid a potentially dangerous situation. In some embodiments, if a safety critical situation cannot be avoided, the system can guide the vehicle to perform a safety stop, e.g., on a shoulder of a highway, until the sun position has changed sufficiently to increase the confidence values for sensors of the vehicle. The determination of whether the sensor confidence value has dropped to a point of requiring driver takeover and/or a safety maneuver can be performed by comparing the camera sensor data relative to data from other sensors of the vehicle. For example, if the object perception data from the camera sensor data, when compared with the LiDAR and/or radar data, shows inconsistencies (e.g., inaccurate or missing object detection), the system can reduce the confidence value in the camera sensor data and applies greater weight to the LiDAR and/or radar data for perception of the environment. In some embodiments, if the inconsistencies in the camera sensor data are detected relative to other sensors of the vehicle, the camera sensor data can be removed entirely from the data fusion for object detection. If the weighted sensor data cannot be sufficiently used to perceive the environment around the vehicle (e.g., LiDAR and/or radar data without camera data), the system can generate an alert to mission control and/or the driver to request driver takeover (or the vehicle can perform a safety maneuver stop, such as on the shoulder of the road).

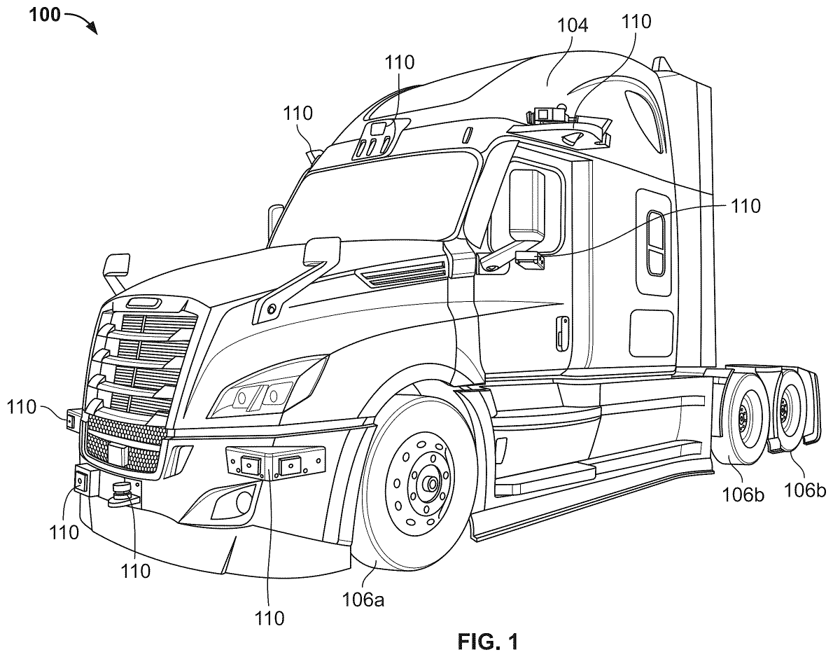

Various embodiments in the present disclosure are described with reference to FIGS. 1-10 below.

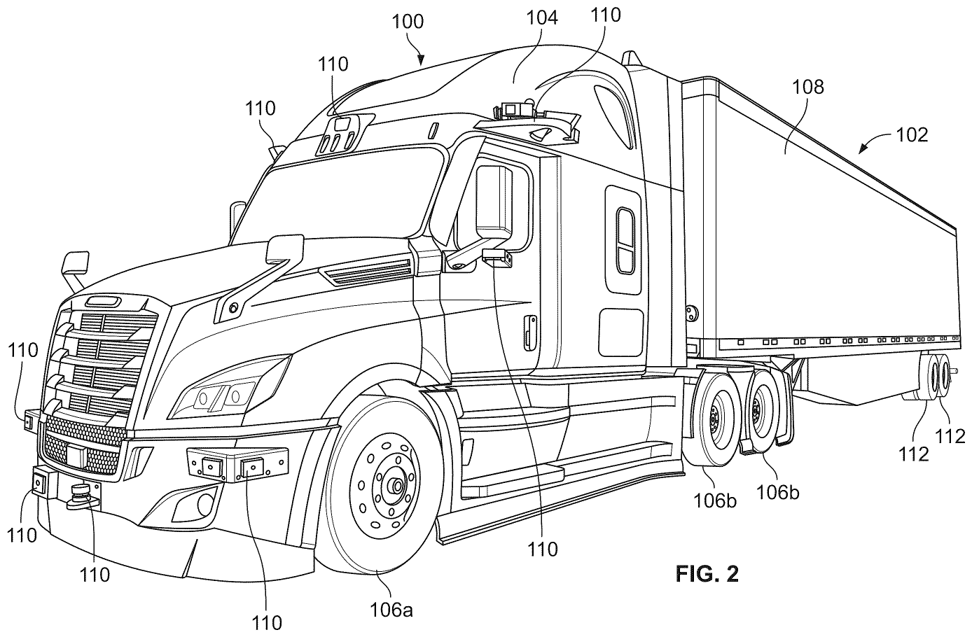

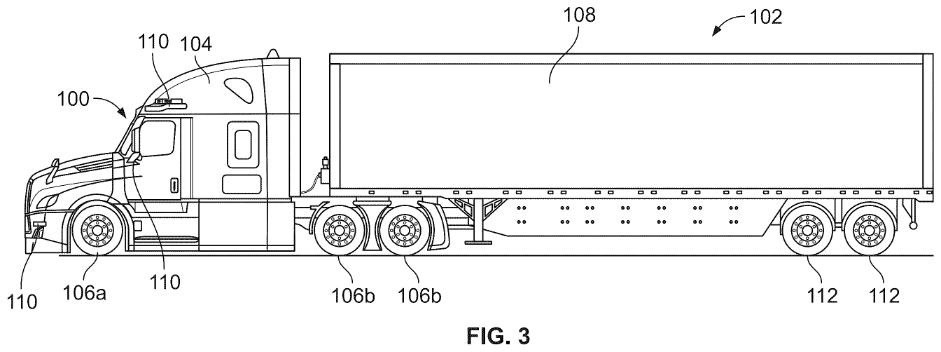

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

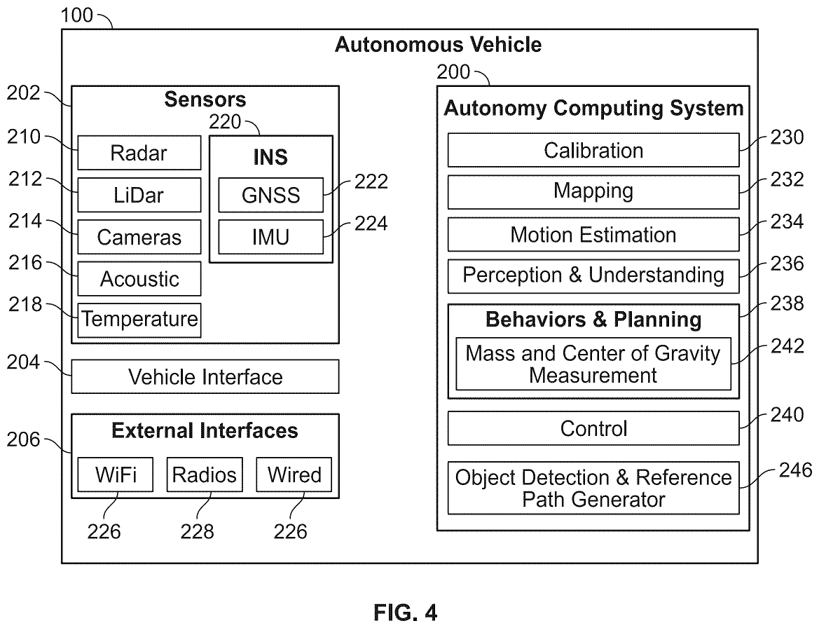

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

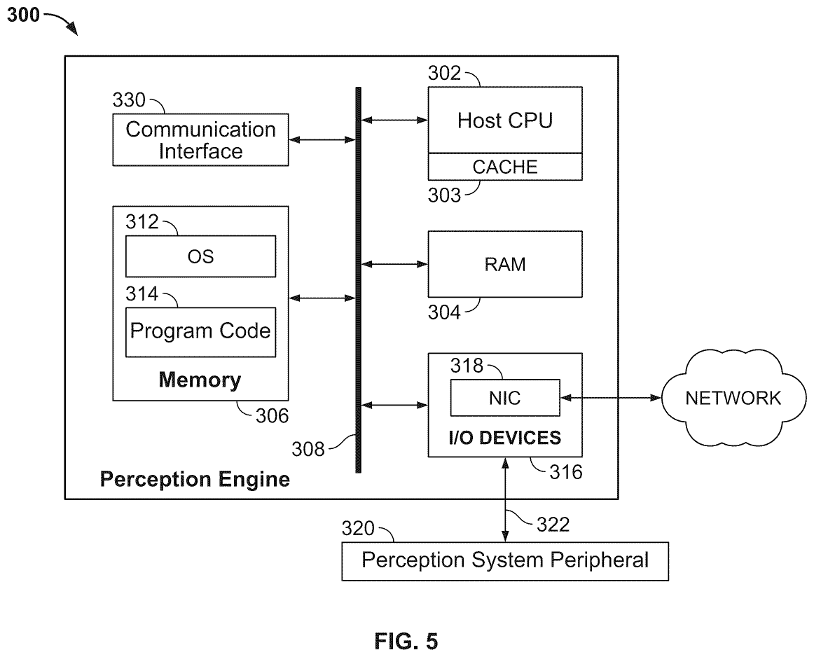

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

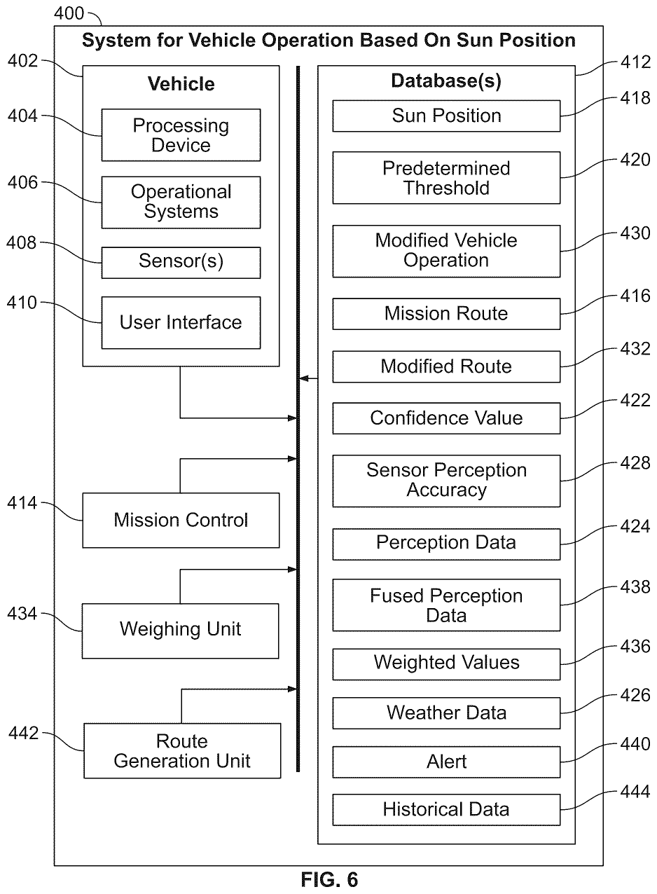

FIG. 6 is a block diagram of an exemplary system 400 for vehicle operation and/or route planning based on sun position. The system 400 generally includes one or more vehicles 402 (e.g., autonomous vehicle 100, semi-autonomous vehicle, and/or non-autonomous vehicle). For semi-autonomous or non-autonomous vehicles, the system 400 can assist individuals with operating the vehicle 402 if there is harder visibility due to the sun position. The vehicle 402 includes a processing device 404 (e.g., computing system 200, computing system 300, or the like) configured to receive and process data for determining operation of the vehicle 402 based on the detected sun position, or for generating a modified route for the vehicle 402 based on the detected or expected sun position. The vehicle 402 can include one or more operational systems 406 (e.g., mapping 232, motion estimation 234, perception and understanding 236, behaviors and planning 242, control 240, object detection and reference path generator 246, combinations thereof, or the like) for operating the vehicle 402 within an environment.

The vehicle 402 can include one or more sensors 408 (e.g., sensors 202) for detecting the environment and objects within the environment around the vehicle 402. The sensors 408 can include, e.g., cameras, radar, LiDAR, combinations thereof, or the like. The vehicle 402 can generally use data from one or a combination of these sensors 408 during normal operation of the vehicle 402. However, as discussed herein, the perception quality and accuracy of cameras (or other optical sensors) can be affected by certain positions of the sun, e.g., during sunrise and sunset when the rays of the sun interfere with capture of components within the field-of-view of the camera. In general, cameras with a field-of-view at the front of the vehicle 402 are affected by the sun more than cameras with a field-of-view towards the sides or rear of the vehicle 402. However, the system 400 can be used for cameras with a field-of-view in one or more directions of the vehicle 402, e.g., interference with a side field-of-view complicates lane switching.

The vehicle 402 includes a user interface 410 (e.g., vehicle interface 204) configured to receive/transmit and display data for operation of the system 400, as well as the vehicle 402 itself. The vehicle 402 can include one or more databases 412 (e.g., memory 306) configured to receive and electronically store data. In some embodiments, the database 412 can be stored externally from the vehicle 402 and the vehicle 402 can be in communication with the external database 412 for receiving and/or transmitting data associated with the system 400. In some embodiments, the database 412 can be located at mission control 414 (or at any other external location proximate a control unit) external to the vehicle 402 and in communication with the vehicle 402. In some embodiments, the database 412 can be located on the vehicle 402 itself. In some embodiments, one or more portions of the database 412 can be distributed across components of the system 400. The database 412 can store information relating to operation of the vehicle 402 based on the sun position.

In particular, the system 400 can operate in a variety of ways to optimize operation of the vehicle 402 by taking into account the position of the sun. In some embodiments, the system 400 can adapt a route for the vehicle 402 in real-time to avoid or reduce such interference from the sun. In some embodiments, the system 400 can dynamically weigh the data received from the sensors 408 and thereby define how the data is used based on interference from the sun. The system 400 will assign a lesser weight to data from the cameras and a greater weight to data supplied to the system 100 from other sensors 408, such as radar and/or LiDAR. In some embodiments, the system 400 can plan a route for the vehicle 402 to proactively avoid or reduce such interference from the sun.

In some embodiments, the vehicle 402 can be programmed to follow a planned mission route 416. As the vehicle 416 travels along the mission route 416, one or more of the sensors 408 can be used to detect the position and/or trajectory of the sun, i.e., the sun position 418. The sun position 418 can include the elevation angle of the sun relative to horizontal (and/or a road surface), for example, as well as the azimuth angle. In some embodiments, the elevation angle of the sun can be determined based on the road surface. A predetermined threshold 420 of the sun position 418 can be used to determine if the perception of the sensors 408 is affected by the sun position 418. In some embodiments, the predetermined threshold 420 can include an elevation angle range of between about, e.g., 0-30° inclusive, 0-25° inclusive, 0-20° inclusive, 0-15° inclusive, 10-30° inclusive, 15-30° inclusive, 20-30° inclusive, 25-30° inclusive, or the like. In some embodiments, the elevation angle range can be measured from the road surface (e.g., a plane defined by the road surface). In such embodiments, based on the change in road surface orientation, the system 400 can dynamically measure the elevation angle relative to the road surface plane. In some embodiments, the elevation angle range can be measured from a horizontal plane extending along a longitudinal axis projecting outward from the front of the vehicle 402. In some embodiments, the predetermined threshold 420 can include an azimuth angle range of between about, e.g., −45° to 45° inclusive, relative to the sensor 408 mounting position on the vehicle 402 (e.g., a central position of the field-of-view of the respective sensor 408).

These angles of the sun generally capture the sunrise and sunset positions of the sun. It should be understood that the elevation and azimuth angle determinations can be performed by the system 400 for each respective sensor 408, and the determination of whether the sensor 408 data should be weighed differently (thereby relying more on different sensor data) is performed independently from other sensors 408. For example, some sensors 408 of the vehicle 400 can include a field-of-view projected towards the general direction of the sun, while other sensors 408 of the vehicle 400 can include a field-of-view projected sufficiently away from the sun to allow for continued data consideration due to unaffected perception.

If the sun position 418 is within the predetermined threshold 420, a confidence value 422 in in the perception data 424 collected from one or more of the sensors 408, e.g., the cameras, can be determined to be lower than during operation of the sensors 408 when the sun position 418 is outside of the predetermined threshold 420. In particular, the accuracy of the perception data 424 can be reduced when the sun position 418 is within the predetermined threshold 420 due to, e.g., sun rays substantially directly passing through the field-of-view of the sensor 408.

In some embodiments, the system 400 can rely strictly on whether the sun position 418 is within the predetermined threshold 420 and, if yes, the system 400 can weigh the camera data to have less or no effect on the perception decisions by the vehicle 402. In some embodiments, the system 400 can compare the camera data relative to other sensor 408 data (e.g., LiDAR and/or radar) and, if differences between the detected objects and/or object lists exist between the camera data and the other sensor 408 data, and the sun position 418 is within the predetermined threshold 420, the system 400 can determine that the camera data is affected by the sun with reduced perception and the system 400 weighs the camera data to have less or no effect on the perception decisions by the vehicle 402 (as compared to the other sensor 408 data). Fusion of the data from the camera and other sensors 408 can therefore be performed differently (e.g., with different weights) based on a comparison of the perception data and the sun position 418.

In some embodiments, the current weather data 426 can be used can be used to confirm whether the sun position 418, within the predetermined threshold 420, does affect the perception data 424. For example, if the current weather data 426 shows cloudy, rainy or snowy conditions, the rays of the sun are blocked and no modification of the vehicle 402 operation is needed. As a further example, if the current weather data 426 shows sunny and clear sky conditions, the rays of the sun affect the perception data 424 and modification of the vehicle 402 operation is needed.

If the sun position 418 is determined to be within the predetermined threshold 420 and the weather data 426 is such that that sun rays affect the sensor perception accuracy 428, operation of the vehicle 402 can be adjusted into a modified vehicle operation 430. The modified vehicle operation 430 can be controlled or initiated by mission control 414 and/or the processing device 404 of the vehicle 402. The modified vehicle operation 430 is intended to route the vehicle 402 in a manner that avoids or reduces exposure of the affected sensor(s) 408 to the sun in the predetermined threshold 420 values.

In some embodiments, the modified vehicle operation 430 can include generating a modified route 432 for the vehicle 402. The modified route 432 can seek to avoid or limit travel of the vehicle 402 along roads that lead east (within the azimuth predetermined threshold 420) during morning hours, i.e., sunrise, and further seeks to avoid or limit travel of the vehicle 402 along roads that lead west (within the azimuth predetermined threshold 420) during afternoon/evening hours, i.e., sunset. The modified route 432 can be generated in substantially real-time and provides an adjustment to the mission route 416 along which the vehicle 402 is already traveling. By using the modified route 432, the vehicle 402 essentially avoids the sun position 418 in the predetermined threshold 420, ensuring that the confidence value 422 of the camera sensors 408 remains high. In some embodiments, the modified route 432 can be along flatter terrain, as compared to hilly terrain, along which the sensors 408 can better adjust or accommodate for the sun position 418 in the predetermined threshold 420. For example, while travelling along hilly terrain, the up and down movement of the vehicle 402 caused by the terrain affects the angle of the sensors relative to the sun position 418, which can increase the frequency of problematic exposure to the rays of the sun.

In some embodiments, a modified route 432 cannot be generated to efficiently allow the vehicle 402 to travel to its intended destination, or cannot sufficiently avoid the sun position 418 in the predetermined threshold 420. In such embodiments, the modified vehicle operation 430 can involve execution of a weighing unit 434 to dynamically weigh the perception data 424 from the sensors 408 of the vehicle. For example, if the vehicle 402 includes sensors 408 in the form of cameras, radar and LiDAR, the perception data 424 of the cameras may be affected by the sun position 418 in the predetermined threshold 420. However, the radar or LiDAR perception data 424 is not affected by the rays of the sun (e.g., secondary sensor data). Therefore, the weighing unit 434 can be executed by the processing device 404 to provide greater weight to the perception data 424 from the radar and/or LiDAR, while reducing the weight of the perception data 424 from the cameras.

Initially, during normal operation, perception data 424 from all sensors 408 can generally be weighted equally. The weighted values 436 can be applied to the perception data 424 for the respective sensors 408, and the resulting data can be fused as fused perception data 438. The fused perception data 438 is different from the perception data 424 based on application of the weighted values 436, resulting in a modified vehicle operation 430. For example, if the camera sensor 408 does not detect an object in front of the vehicle 402 due to interference from the rays of the sun, but other sensors 408 of the vehicle 402 (e.g., radar and/or LiDAR) detect an object, the other sensor 408 data can be used with greater weight to ensure the vehicle 402 operates with the detected object in front of it, i.e., the camera sensors 408 have a low confidence value 422. As a further example, if the sun position 418 affects the perception of the camera, the weighing unit 434 can reduce the confidence value, i.e., weighted value 436 from 100% to 95%, 90%, 80%, 70%, or the like, to reduce the weight given to the camera data. In some embodiments, the weighing or confidence value for the camera sensor data can be reduced to 0% and the vehicle 402 can operate entirely on the other sensor 408 data (e.g., radar, LiDAR, or the like). Thus, if the camera perception data is found to be inadequate or inaccurate, the system 400 can shift the weight ratio of camera/other sensor data from generally 50%/50%, to 20%/80% or 0%/100%, for example.

The operational systems 406 can therefore rely on the fused perception data 438 to operate the vehicle 402, ensuring that the more reliable data from the sensors 408 is used to guide the vehicle 402 through the environment. In such embodiments, the weighing of the perception data 424 can be dynamically performed based on the detected sun position 418. For example, as the sun position 418 moves within the predetermined threshold 420, the effect of the rays of the sun may be diminished, and the weighted values 436 can be dynamically updated in real-time to gradually increase the weight applied to the camera sensor 408.

In some embodiments, the modified vehicle operation 430 can involve at least partially reducing the velocity of the vehicle 402 to ensure a safer, i.e., greater, distance is maintained for potential deceleration of the vehicle 402. In some embodiments, if a modified route 432 and/or weighted perception data 424 cannot be used to ensure safe operation of the vehicle 402, the system 400 can generate an alert 440 to either mission control 414 and/or a driver of the vehicle 402 via the user interface 410. In some embodiments, the alert 440 can indicate the deficient perception data 424 from the camera sensor 408, requesting that the driver of the vehicle 402 operate the vehicle 402 manually. In some embodiments, if a driver is not within the vehicle 402 (i.e., an autonomous vehicle), the alert 440 can indicate that a minimal risk maneuver should be performed by the vehicle 402, e.g., pulling over on the side of the road until the sun position 418 is outside of the predetermined threshold 420. In some embodiments, the alert 440 can be generated if the confidence value 422 falls below a predetermined value, indicating that the available sensor 408 data cannot be used to safely operate the vehicle 402.

In some embodiments, the system 400 can be used to proactively plan a mission route 416 for the vehicle 402 to avoid or minimize instances of the sun position 418 affecting the perception of the sensors 408. Rather than adjusting the mission route 416 into a modified route 432 after the vehicle 402 has already traveled along a portion of the mission route 416, the system 400 can generate the mission route 416 to minimize the diminished perception data 424 due to the sun position 418 before the vehicle 402 departs for the mission route 416.

The route generation unit 442 can be executed by mission control 414 and/or the processing device 404 to process historical data 444 regarding the sun position and routes taken by the vehicle 402 (or other vehicles). Forecasted weather data 426 can be used by the route generation unit 442 to further determine the effect of the sun position during the generated route. The historical data 444 can include the expected position of the sun (including elevation and azimuth values) for different available routes between a starting location and a destination location. The mission route 416 generated based on the historical data 444 can, e.g., ensure travel of the vehicle 402 opposite of the sun travel position, a direction of travel west during morning travel, a direction of travel east during evening travel, or the like. If the sun position 418 within the predetermined threshold 420 cannot be effectively avoided in the mission route 416, the weighing unit 434 can be executed during travel along the mission route 416 to weigh the perception data 424 as discussed herein.

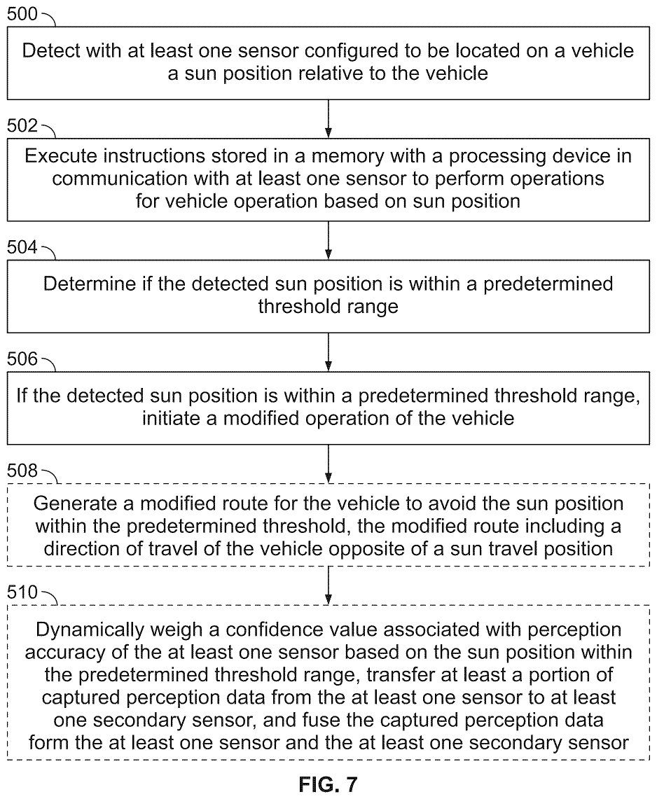

FIG. 7 is a flowchart of a method of vehicle operation based on sun position by the exemplary system 400 discussed herein. At 500, a sun position relative to the vehicle is detected with at least one sensor configured to be located on a vehicle. At 502, instructions stored in a memory are executed with a processing device in communication with at least one sensor to perform operations for vehicle operation based on sun position. At 504, a determination is made if the detected sun position is within a predetermined threshold range.

At 506, if the detected sun position is within a predetermined threshold range, the system initiates a modified operation of the vehicle. At 508, in some embodiments, the method can include generating a modified route for the vehicle to avoid the sun position within the predetermined threshold. The modified route includes a direction of travel of the vehicle opposite of a sun travel position. At 510, in some embodiments, the method can include dynamically weighing a confidence value associated with perception accuracy of the at least one sensor based on the sun position within the predetermined threshold range. The method includes transferring at least a portion of the captured perception data from the at least one sensor to at least one secondary sensor, and fusing the captured perception data from the at least one sensor and the at least one secondary sensor.

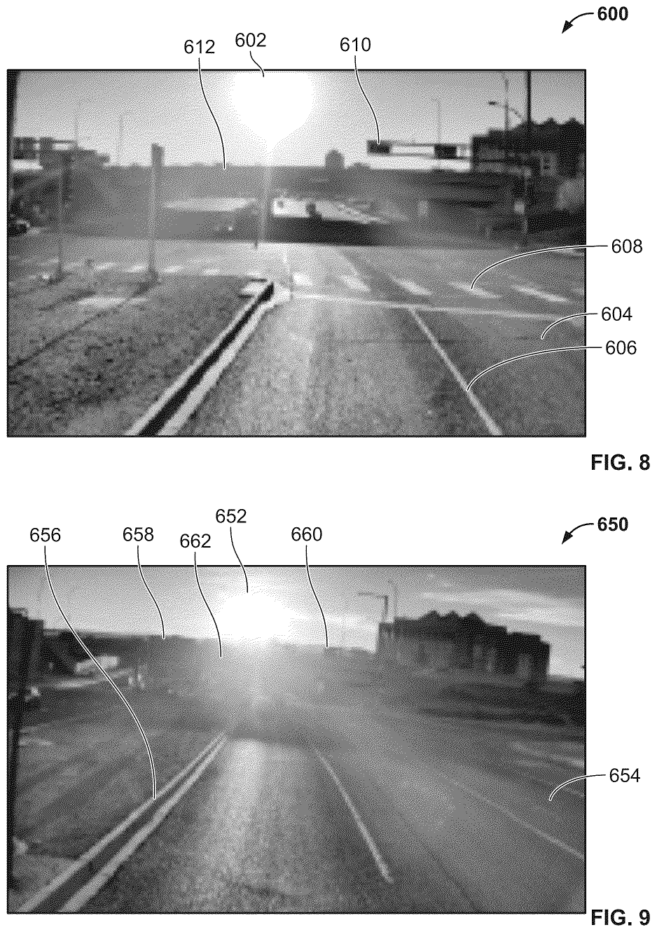

FIG. 8 is an image 600 captured by a camera sensor of a vehicle during a sun 602 position outside of the predetermined threshold range. When the sun 602 is in this position, and outside of the predetermined threshold range, the camera sensor is able to accurately detect objects in the environment around the vehicle. For example, the perception data in the image 600 is sufficiently high in confidence level (based on visibility of objects and details in the image 600) and as a result, the road 604, lane markings 606, crosswalks 608, streetlights 610, bridges 612, or the like, are capable of being detected. In some embodiments, due to high contrast, the object and/or edge detection performed by the system in the image 600 can be segmented.

FIG. 9 is an image 650 captured by a camera sensor of a vehicle during a sun 652 position within the predetermined threshold range. When the sun 652 is in this position, and within the predetermined threshold range, interference from the rays of the sun 652 results in a reduced ability of the system to effectively perceive objects in the environment around the vehicle with the camera sensor. Although the road 654 and lane markings 656 may still be generally visible, street signs 658, streetlights 660 and bridges 662 (as non-limiting examples) are barely visible in the image 650, i.e., a low confidence level back on lack of visibility of objects. For example, although the radar and/or LiDAR data can detect the objects in the image 650, the sensor data can lack sufficient detection or identification of the objects in the image 650, e.g., inconsistent comparable data between sensor types. Due to the direct sun 652 position, the image 650 illustrates a blooming effect. As such, it is not possible for the system to detect and extract edges and colors of objects, such as traffic participants or traffic signs/lights. In such instances, the system can decrease the weight applied to the camera data, and greater weight can be applied to other sensors of the vehicle to detect objects in the environment and make decisions on operation of the vehicle in the environment. Thus, if perception of objects is diminished in the camera sensor data, the exemplary system can be operated to function in a modified manner to ensure safe operation of the vehicle through the environment.

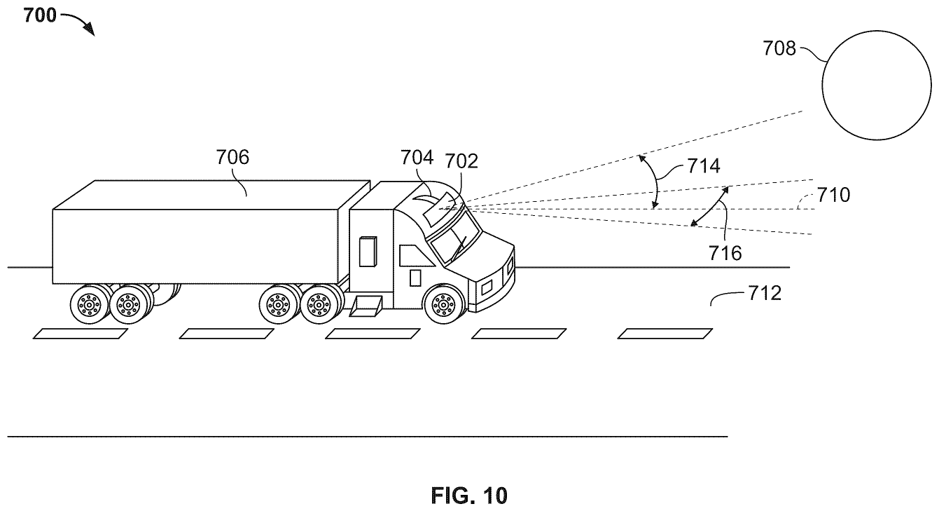

FIG. 10 is a schematic side view of a vehicle 700 including a sensor 702. In some embodiments, the vehicle 700 can include a truck 704 and a trailer 706. Although the sensor 702 is shown at the front of the vehicle 700, it should be understood that a similar operation of the system can be performed for other sensors of the vehicle 700. In some embodiments, the implementation of the system (e.g., weighing of perception data) can be performed for each optic sensor 702 independently based on the field-of-view of the respective sensors 702 and the effect of the sun 708 position relative to the respective sensors 702.

In some embodiments, the position of the sun 708 can be determined relative to horizontal 710. In some embodiments, the position of the sun 708 can be determined relative to a plane defined by the road 712. The sun 708 position can include an elevation angle 714. When the sun 708 is within a predetermined threshold range of the elevation angle 714, interference of the rays of the sun 708 can result in reduced perception of the sensor 702 data. The sun 708 position can also include an azimuth angle 716, e.g., an angle measured to the right and left of the front of the vehicle 700 (or in the field-of-view of the sensor 702, depending on the sensor 702 position). The azimuth angle 716 can also include a range in which the rays of the sun 708 can result in reduced perception of the sensor 702 data, as long as the sun 708 is within the elevation angle 714 predetermined threshold range.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for vehicle operation based on sun position, the system comprising:
at least one sensor configured to be located on a vehicle; and
a processing device in communication with the at least one sensor, wherein the processing device is configured to execute instructions stored in a memory to perform operations comprising:
detecting with the at least one sensor a sun position relative to the vehicle;
determining if the detected sun position is within a predetermined threshold range; and
if the detected sun position is within the predetermined threshold range, initiating a modified operation of the vehicle.

2. The system of claim 1, wherein detecting with the at least one sensor the sun position relative to the vehicle comprises determining the sun position relative to a horizontal plane extending in front of the vehicle.

3. The system of claim 2, wherein the predetermined threshold range includes an angle of 30 degrees or less from the horizontal plane.

4. The system of claim 1, wherein detecting with the at least one sensor the sun position relative to the vehicle comprises determining the sun position relative to a horizontal plane defined by a road in front of the vehicle.

5. The system of claim 1, wherein the sun position relative to the vehicle includes an azimuth value and an elevation value.

6. The system of claim 1, wherein the sun position is within the predetermined threshold range during sunrise or sunset.

7. The system of claim 1, wherein initiating the modified operation of the vehicle comprises generating a modified route for the vehicle to avoid the sun position within the predetermined threshold.

8. The system of claim 7, wherein the modified route includes a direction of travel of the vehicle opposite of a sun travel position.

9. The system of claim 8, wherein the modified route includes the direction of travel west during morning travel and the direction of travel east during evening travel of the vehicle.

10. The system of claim 1, wherein initiating the modified operation of the vehicle comprises dynamically weighing a confidence value associated with perception accuracy of the at least one sensor based on the sun position within the predetermined threshold range.

11. The system of claim 10, wherein the operations comprise transferring at least a portion of captured perception data from the at least one sensor to at least one secondary sensor, and fusing the captured perception data from the at least one sensor and the at least one secondary sensor.

12. The system of claim 11, wherein the operations comprise assigning greater weight to the captured perception data from the at least one secondary sensor than to the captured perception data from the at least one sensor.

13. The system of claim 11, wherein a perception capability of the at least one sensor is affected by the sun position in the predetermined threshold range, and wherein a perception capability of the at least one secondary sensor is not affected by the sun position in the predetermined threshold range.

14. The system of claim 13, wherein the at least one sensor is a camera, and the at least one secondary sensor is at least one of LiDAR or radar.

15. The system of claim 1, wherein initiating the modified operation of the vehicle comprises reducing a speed of the vehicle for safer travel during reduced perception with the at least one sensor.

16. The system of claim 1, wherein initiating the modified operation of the vehicle comprises generating a modified route for the vehicle with flat terrain.

17. The system of claim 1, wherein initiating the modified operation of the vehicle comprises at least one of (i) generating a modified route for the vehicle to avoid the sun position within the predetermined threshold, (ii) dynamically weighing a confidence value associated with perception accuracy of the at least one sensor based on the sun position within the predetermined threshold range, transferring at least a portion of captured perception data from the at least one sensor to at least one secondary sensor, and fusing the captured perception data from the at least one sensor and the at least one secondary sensor, (iii) reducing a speed of the vehicle for safer travel during reduced perception with the at least one sensor, (iv) generating a modified route for the vehicle with flat terrain, (v) modifying the speed of the vehicle, (vi) performing a minimal risk maneuver, or (vii) increasing a safety distance relative to other road users.

18. A computer-implemented method for vehicle operation based on sun position, comprising:
detecting with at least one sensor configured to be located on a vehicle a sun position relative to the vehicle; and
executing instructions stored in a memory with a processing device in communication with the at least one sensor to perform operations comprising:
determining if the detected sun position is within a predetermined threshold range; and
if the detected sun position is within a predetermined threshold range, initiating a modified operation of the vehicle.

19. The method of claim 18, wherein initiating the modified operation of the vehicle comprises at least one of (i) generating a modified route for the vehicle to avoid the sun position within the predetermined threshold, wherein the modified route includes a direction of travel of the vehicle opposite of a sun travel position, (ii) reducing a speed of the vehicle for safer travel during reduced perception with the at least one sensor, or (iii) increasing a safety distance relative to other road users.

20. The method of claim 18, wherein initiating the modified operation of the vehicle comprises dynamically weighing a confidence value associated with perception accuracy of the at least one sensor based on the sun position within the predetermined threshold range, and wherein the operations comprise transferring at least a portion of captured perception data from the at least one sensor to at least one secondary sensor, and fusing the captured perception data from the at least one sensor and the at least one secondary sensor.
